(19) United States
(12) Patent Application Publication
(10) Pub. No.: US 2015/0177899 A1
(43) Pub. Date: Jun. 25, 2015

(54) Elastomeric shear Material Providing Haptic Response Control

(71) Applicant: Apple Inc., Cupertino, CA (US)

(72) Inventors: Brett W. Degner, Cupertino, CA (US); Peteris k. Augenbergs, Cupertino, CA (US); Christiaan A. Ligtenberg, Cupertino, CA (US); Jonah A. Harley, Cupertino, CA (US); Patrick Kessler, San Francisco, CA (US); John M. Brock, San Carlos, CA (US); Thomas W. Wilson, JR., Saratoga, CA (US)

(21) Appl. No.: 14/417,537

(22) PCT Filed: Mar. 15, 2013
(86) PCT No.: PCT/US2013/031814

§ 371 Date: Jan. 26, 2015

Related U.S. Application Data
(60) Provisional application No. 61/675,993, filed on Jul. 26, 2012.

(51) Int. Cl. G06F 3/041; G06F 3/046

(52) U.S. Cl. CPC G06F 3/0414; G06F 3/046

(57) ABSTRACT

A haptic response element is contemplated. The haptic response element may generate a tactile feeling as an output and is associated with a computing device. The tactile feeling may be created by moving a part of the haptic response element. A gel may act to return the moving part of the haptic response element to a starting or zero point. Motion of the moving part may exert a shear force on the gel, rather than a compressive force.

### CROSS REFERENCE TO RELATED APPLICATIONS

This Patent Cooperation Treaty patent application claims priority to U.S. provisional application No. 61/675,993, filed Jul. 26, 2012, and entitled, “Elastomeric Shear Material Providing Haptic Response Control,” the contents of which are incorporated herein by reference in its entirety.

### TECHNICAL FIELD

The present invention generally relates to controlling a haptic response, and more particularly to employing an elastomeric material to control a haptic response.

### BACKGROUND

Haptic response elements are becoming increasingly common in computing devices. They provide tactile feedback, thereby enabling a wider range of output in response to certain conditions, such as user input, software states and/or operations, error conditions, acknowledgements, and more. Haptic response may be combined with or into an input device, such that the input device may not only accept user input but provide haptic feedback. Haptic response elements generally provide tactile feedback by moving or otherwise actuating a touched portion of the element between a start and travel position. The motion may be repeated multiple times in some embodiments and/or at varying frequencies, but some motion is generally required.

However, haptic response elements to date have generally been somewhat difficult to control. Many haptic response elements do not produce crisp, pleasant tactile outputs. Rather, their pout puts may resemble a buzz or vibration. Not only do some users find this sensation unpleasant, but these sensations require some time to produce (and sense) and some time to terminate. For example, a vibratory motion may need to build to a harmonic frequency to provide sufficient force to be sensed by a user.

In many cases, it may be difficult to adequately damp or otherwise control a haptic response element in order to provide a solid-feeling output. Part of this difficulty may arise from an inability to quickly return the touched portion of the haptic response element to its starting point from its travel position. Springs are often used to bias the touched portion back to the start position, but springs often lack damping capabilities.

Likewise, viscoelastic polymers may be used to return the touched portion of the haptic response element from its travel position to its start position. Typically such elastomers are placed in tension or compression when the touched portion travels, which causes the elastomer to react in a similar fashion as a spring (e.g., exerting a non-linear force when returning the touched portion to the start position from the travel position).

### SUMMARY

Embodiments described herein may take the form of an input device capable of sensing a force and providing a haptic output in response to the sensed force.

A haptic response element is contemplated. The haptic response element may generate a tactile feeling as an output and is associated with a computing device. The tactile feeling may be created by displacing a part of the haptic response element. A gel may act to return the moving part of the haptic response element to a starting or zero point. Displacement of the moving part may exert a shear force on the gel, rather than a tensile compressive force.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

FIGS. 1A-1C illustrate a standard bending beam strain sensor for load measurement in several configurations.

FIG. 1D shows a circuit diagram for a standard bending beam strain sensor including one strain gauge.

FIG. 1E shows a circuit diagram for a standard bending beam strain sensor including four strain gauges.

FIG. 2 illustrates a circuit diagram for a standard bending beam strain sensor.

FIG. 3A illustrates a moment compensated bending beam sensor including two strain gauges or two pairs of strain gauges on one side of a beam for load measurement in an embodiment.

FIG. 3B illustrates a top view of a moment compensated bending beam sensor including two strain gauges in an embodiment.

FIG. 3C illustrates a top view of a moment compensated bending beam sensor including two pairs of strain gauges or four strain gauges in an embodiment.

FIG. 3D illustrates a side view of a moment compensated bending beam with a flexible support in one embodiment.

FIG. 3E illustrates a side view of a moment compensated bending beam with a flexible support in another embodiment.

FIG. 4 illustrates a diagram of electrical connection for the two strain gauges for a moment compensated bending beam sensor in an embodiment.

FIG. 5 illustrates a Wheatstone bridge connection for the two pairs of strain gauges for a moment compensated bending beam sensor in an embodiment.

FIG. 6A is a top view of a moment compensated bending beam sensor including two strain gauges on a common carrier aligned with a bending beam in an embodiment.

FIG. 6B is a top view of a moment compensated bending beam sensor including four strain gauges on a common carrier aligned with a bending beam in another embodiment.

FIG. 7A is a top view of a system diagram for a trackpad (TP) supported with four bending beams and load measurements with four moment compensated bending beam sensors in an embodiment

FIG. 7B is a cross-sectional view through bending beam 702A of FIG. 7A.

FIG. 7C illustrates a top view of a platform with four bending beams under forces at various force locations in an embodiment.

FIG. 8A is a perspective view of the bottom of a trackpad with four bending beams at the corners in another embodiment.

FIG. 8B is an enlarged view of one of the four beams at a corner of FIG. 8A in an embodiment.

FIG. 9 is a flow chart illustrating the steps for fabricating a moment compensated bending beam sensor coupled to a touch input device in an embodiment.

FIG. 10 is exemplary strain profiles with a moment compensated bending beam sensor including four strain gauges aligned with a beam.

FIG. 11 is an exemplary trackpad in an embodiment.

FIG. 12A illustrates one sample force output along path A of FIG. 11 from a moment compensated bending beam sensor and a standard bending beam strain sensor or a non-moment compensated bending beam sensor for a 0.8 mm thick platform.

FIG. 12B illustrates one sample force output along path B of FIG. 11 from a moment compensated bending beam sensor and a standard bending beam strain sensor or a non-moment compensated bending beam sensor for a 0.8 mm thick platform.

FIG. 13A illustrates one sample force output along path A of FIG. 11 from a moment compensated bending beam sensor for a 2.3 mm thick platform.

FIG. 13B illustrates one sample force output along path B of FIG. 11 from a moment compensated bending beam sensor for a 2.3 mm thick platform.

FIG. 14A illustrates a sample linearity of a moment compensated bending beam sensor output as a function of load for a 2.3 mm thick platform.

FIG. 14B illustrates a sample moment compensated bending beam sensor deviation from linearity for a 2.3 mm thick platform.

FIG. 15 is a flow chart illustrating the steps for determining a force and a location of the force for a trackpad with a moment compensated bending beam sensor in an embodiment.

FIG. 16 is a simplified system diagram for a trackpad in an embodiment.

### DETAILED DESCRIPTION

Generally, embodiments discussed herein may take the form of a sensor for determining a load or force, or structures that operate with such sensors. As one example, a trackpad may be associated with one or more force sensor, as discussed herein. As force is applied to the trackpad, the sensor(s) may detect a strain. That strain may be correlated to the force exerted on the trackpad and thus an amount of force exerted may be determined. Further, by employing multiple sensors in appropriate configurations, a location at which a force is applied may be determined in addition to a magnitude of the force.

A gel or elastomeric material may be employed in the trackpad. For example, the gel may

The present disclosure may be understood by reference to the following detailed description, taken in conjunction with the drawings as briefly described below. It is noted that, for purposes of illustrative clarity, certain elements in the drawings may not be drawn to scale.

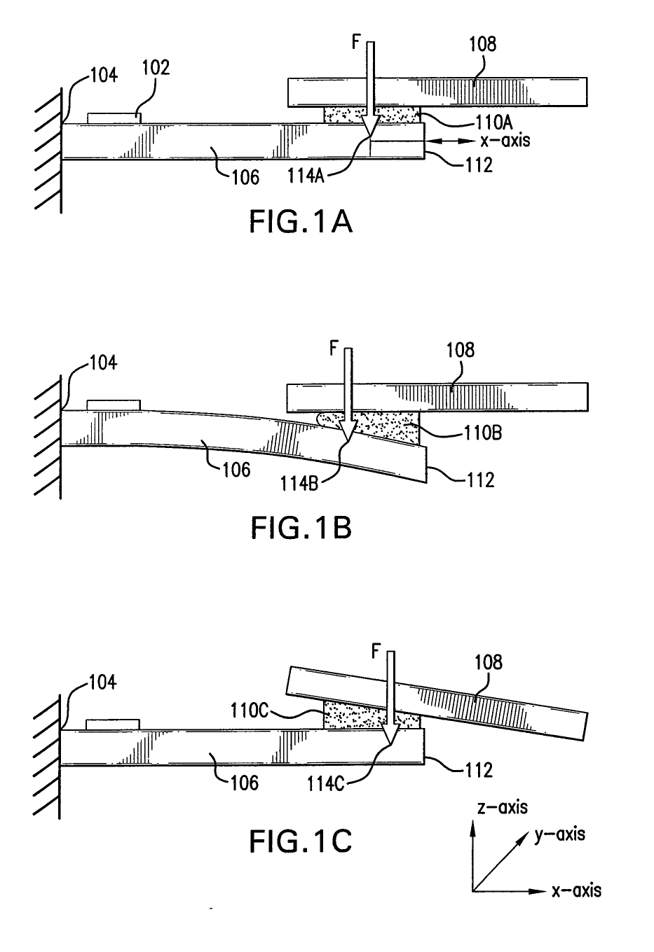

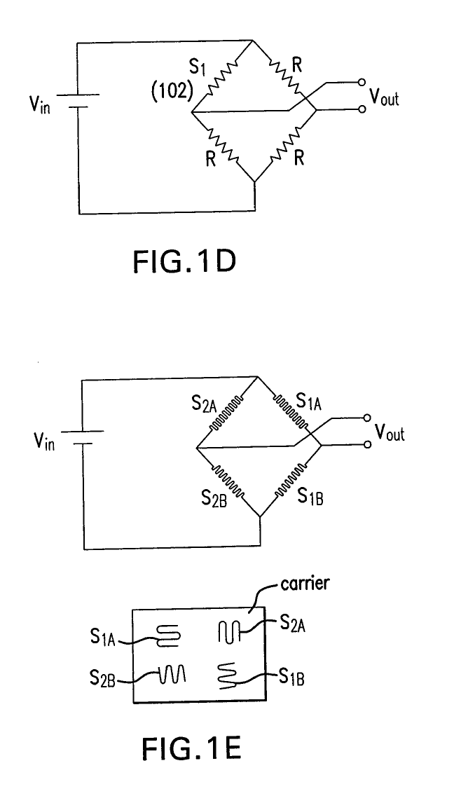

FIGS. 1A-1C illustrate a bending beam strain sensor on a beam and used for load measurement; each of FIGS. 1A-1C illustrates the beam sensor and beam in several configurations when load position varies along the beam. The beams may be used to support a force-sensitive trackpad, for example.

FIG. 1A shows that a bending beam strain sensor 102 is placed near a beam base 102 of a beam 106 and positioned horizontally along an X-axis. The standard bending beam strain sensor 102 is oriented so it responds to strain along the X-axis. In the embodiment, a trackpad plate 108 is substantially parallel to the beam 106 and a sensor 102 aligned with an axis of the beam. This axis is labeled as the “X-axis” in the figure. The trackpad 108 is attached to the bending beam 106 through a gel 110.

Still with reference to FIG. 1A, a load is vertically applied through a center 114C of the gel 110 along a Z-axis. In this case, the gel layer 110A has a uniform thickness but in alternative embodiments the gel may non-uniform or differently shaped. The trackpad 108 may be a platform or a plate.

As shown in FIG. 1B, as the force is applied, the gel is compressed toward the beam base 104. The beam 106 is bent such that the force is applied through the gel 110B at a force location 114B closer to the beam base 104 than force location 114A.

Referring now to FIG. 1C, the gel is compressed near a free end or edge 112 such that the force is applied through the gel 110C at a force location 114C closer to the free end 112 than force location 114A. The strain detected at strain sensor 102 depends on both the magnitude of the applied force and the position of the force along the beam as well as any additional moments applied to the beam. Because the position of the applied force F can change, as illustrated in FIGS. 1A-1C, the standard bending beam strain sensor 102 has a non-uniform response to the position 114 of the load or force. Further operation and function of the gel is discussed in more detail below.

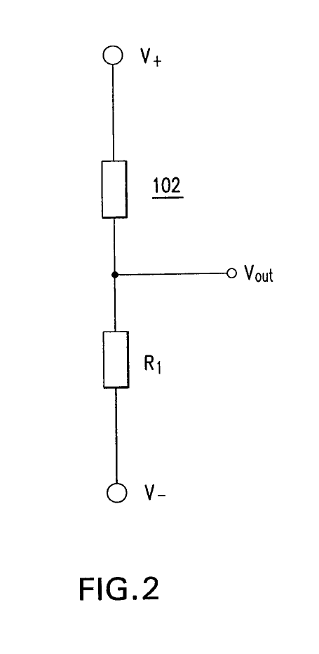

FIG. 2 shows a circuit diagram for a standard bending beam strain sensor 102 including one strain gauge, in accordance with one embodiment. Strain gage S1 and one constant resistor are connected as shown; this configuration is commonly called a half-bridge. The resistor R₁ is chosen to be nearly equal to the resistance of the standard bending beam strain sensor 102 so that the output voltage Vₒᵤₜ generally lies midway between V₊ and V₋. When a force is applied to the beam as shown in FIG. 1B, the beam is bent and a strain is generated at the standard bending beam strain sensor 102, which in turn changes the resistance of the standard bending beam strain sensor 102 and thus the output voltage Vₒᵤₜ.

FIG. 1D shows a circuit diagram for a standard bending beam strain sensor 102 including one strain gauge in one embodiment. Strain gauge S1 and three constant resistors R are connected in a full Wheatstone bridge. When a voltage supply Vᵢₙ is applied, an output voltage Vₒᵤₜ is generated. When the beam is bent, a strain is generated which changes the resistance of standard bending beam strain sensor 102 and changes the output voltage Vₒᵤₜ.

FIG. 1E shows a circuit diagram for a standard bending beam strain sensor including four strain gauges in another embodiment. The standard bending beam strain sensor may include four strain gauges S1A, S1B, S2A, and S2B electrically connected in a full Wheatstone bridge. The strain gauges are arranged as shown in FIG. 1E. The strain sensors are co-located such that S1A and S1B detect the strain parallel to the x-axis and S2A and S2B detect the Poisson strain generated by the strain parallel to the x-axis. Again, when a voltage supply Vᵢₙ is applied, an output voltage Vₒᵤₜ is generated.

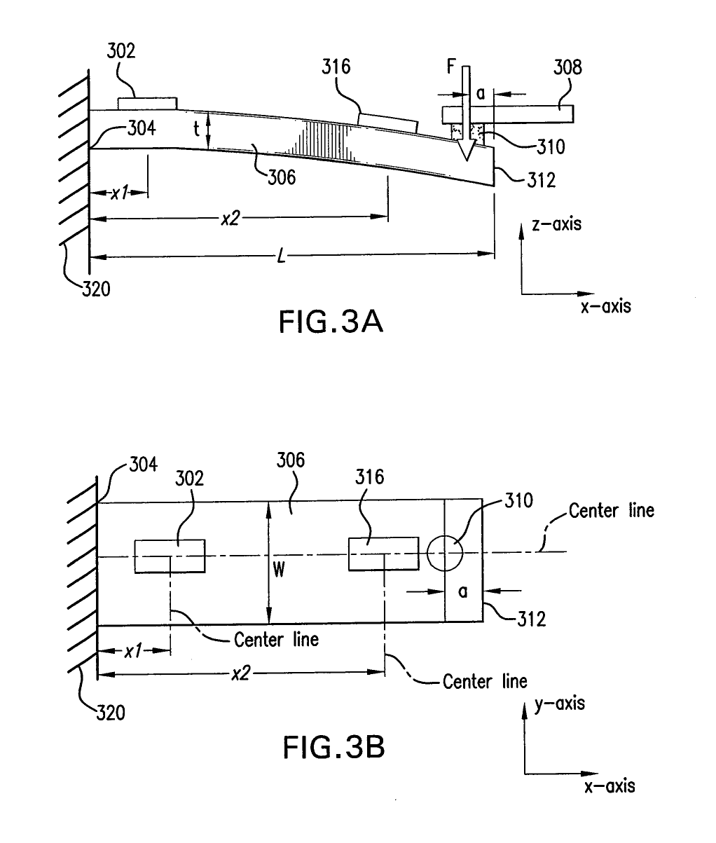

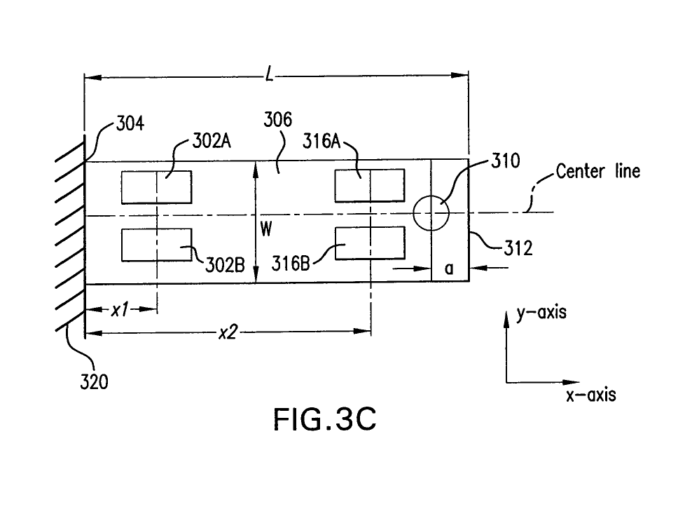

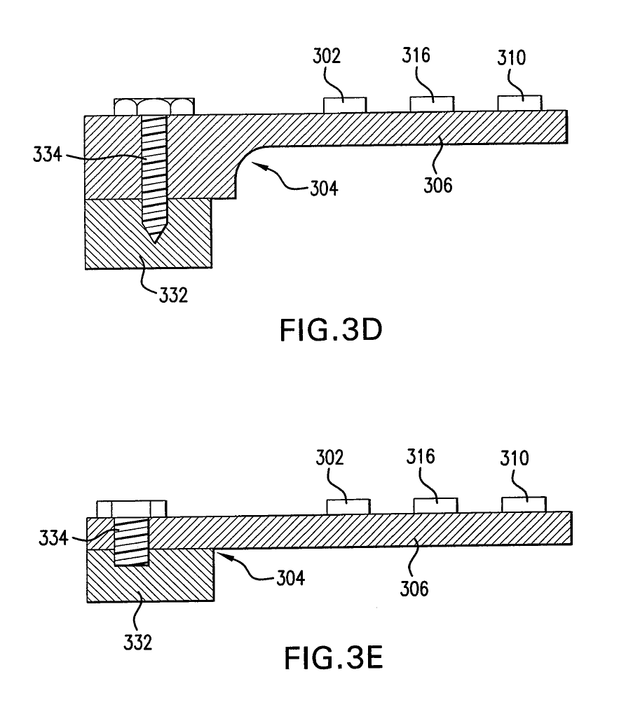

FIG. 3A illustrates a side view of a moment compensated bending beam sensor including at least two strain gauges on one side of a beam for load measurement in an embodiment. The moment compensated bending beam sensor uses the at least two strain gauges differentially to subtract out any applied moments. FIG. 3B illustrates a top view of a moment compensated bending beam sensor including two strain gauges in one embodiment. FIG. 3C illustrates a top view of a moment compensated bending beam sensor including two pairs of strain gauges or four strain gauges in another embodiment.

As shown in FIGS. 3A-C, a first strain gauge 302 or a pair of strain gauges 302A-B is placed at or near a beam base 304 or root of a beam 306 oriented along its axial axis, labeled as X-axis, a second strain gauge 316 or a pair of strain gauges 316A-B is placed near a free end 312 of the beam 306 also oriented along the axis of the beam. The strain gauges 302 and 316, or 302A-B and 316A-B are oriented so they respond to strain along the X-axis. The second strain gauge or pair of strain gauges may be closer to the beam base 304 or root of the beam than a support or connection 310 between the beam 306 and plate 308. More specifically, the center of the second strain gauge 316 may be closer to the base of the beam than the center of the support or connection 310 between the beam 306 and plate 308. Note that the beam bends near the free end 312 of the beam such that the free end 312 is angled from the end of the beam at the beam base 304 under the applied force F.

In certain embodiments, the support or connection 310 may be a viscoelastic polymer, such as a gel. The term “gel” may refer to any suitable, deformable substance that connects the beam and plate. In some embodiments, an adhesive may be used in place of, or in addition to, a gel. In other embodiments, the gel may be omitted. In still further embodiments, a mechanical fastener may affix the beam and plate.

In FIG. 3A, the beam 306 is shown as being attached to a rigid support 320. In an alternative embodiment, the rigid support 320 may be replaced by a flexible support 332, such as shown in FIGS. 3D and 3E. The beam may be clamped or welded to the flexible support 332 by fastener 332. The flexible support 332 may be substantially stiffer than the beam 306.

In another embodiment, as shown in FIG. 3D. the beam end near beam base 304 may formed by thickening the beam. For example, the thickness of the beam may be changed dramatically (1.5× to 5× thickness) to create a stiffness change. As shown in FIG. 3E, the beam may not have any thickening toward the end.

In yet another embodiment, the beam width may be changed to produce a stiffness change. In still yet another embodiment, any combination of the beam thickness variation, beam stiffness variation, beam width change may also create an end substantially stiffer than the beam. In a further embodiment, the beams may have both ends connected to a flexible support or a rigid support. In yet a further embodiment, the two ends of the beam may have a combination of the beam thickness variation, beam stiffness variation, beam width change, which may create two ends substantially stiffer than the beam.

The beam may have a uniform thickness between the two strain gauges 302 and 316. Alternatively, the thickness or width of the beam may change between the two strain gauges. Mathematically, the curvature between the two strain gauges 302 and 316 has a second derivative of zero under an applied load or force. Generally during operation, there are no external loads or forces applied between the two strain gauges.

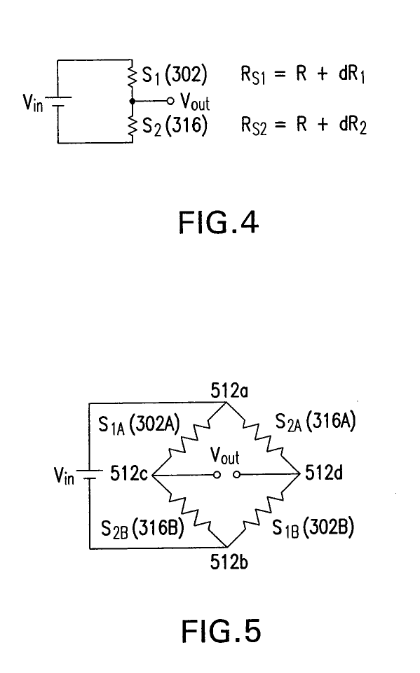

In one embodiment, the two strain gauges 302 and 316 are connected electrically as one arm of a Wheatstone bridge (see FIG. 4). A force applied to the free end of the bending beam will induce a moment that changes along the length of the beam. This will induce different magnitude changes in resistance at the two strain gauges and cause the output of the half Wheatstone bridge to change. This output is a differential output from the two strain gauges 302 and 316. In an alternative embodiment, the strain gauges may be connected to separate half bridges. The signals from these separate bridges may be subtracted using an analog or digital circuit. In some instances, it may be necessary to apply separate scaling to each signal before they are subtracted.

The output voltage for the moment compensated bending beam sensor is a differential signal of the output from the two strain gauges 302 (S1) and 316 (S2). At strain gauge 302,

M₁=F(L−x₁−a) Equation (1)

ε₁=M₁t/2EI Equation (2)

dR₁=RGε₁ Equation (3)

At strain gauge 316,

M₂=F(L−x₂−a) Equation (4)

ε₂=M₂t/2EI Equation (5)

dR₂=RGε₂ Equation (6)

where M₁ and M₂ are the moments, and ε₁ and ε₂ are the strains, E is the Young's modulus, I is the moment of inertia of the beam, dR₁ and dR₂ are the resistance changes of the respective strain gauges 302 and 316, R is the resistance of each of the strain gauges 302 and 316, G is the gauge factor of the strain gauges, t is the thickness of the beam, w is beam width, and L is the length of the beam. a is the position of the force, or the distance of the load from the free end 312 of the beam 306. In some embodiments, the resistances of the two strain gauges may not be equal.

Note that both dR₁ and dR₂ depend upon the beam length L and the position of the force a. However, a differential signal Δ is independent of the beam length L and the position of the force a. The differential signal is the difference between dR₁ and dR₂, which is expressed as follows:

Δ=dR₁−dR₂=RGtF(X₂−X₁)/2EI Equation (7)

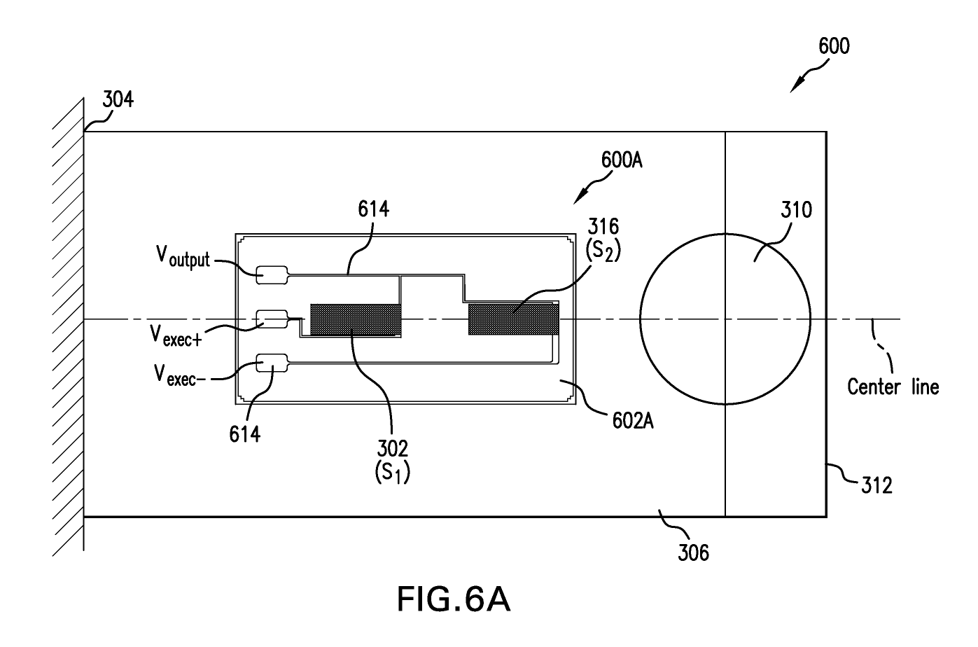

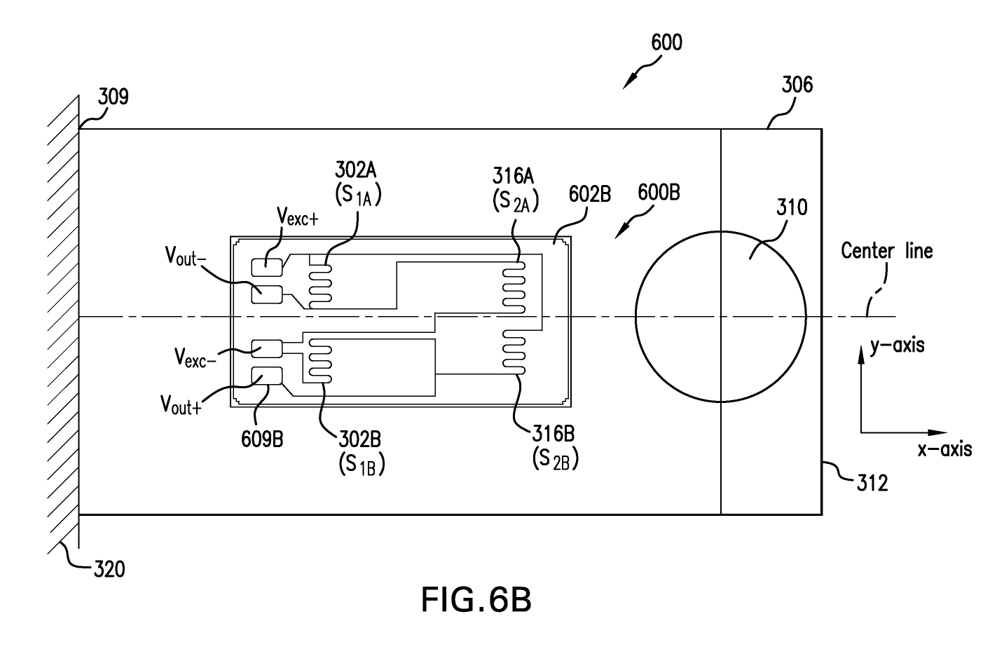

In an alternative embodiment, four strain gauges 302A-B and 316A-B are connected electrically as a full Wheatstone bridge. FIG. 5 is a circuit diagram for electrical connections of Wheatstone bridge for a moment compensated bending beam sensor, including four strain gauges, in accordance with another embodiment. The output voltage Vₒᵤₜ does not depend on the position of the force or the length of the beam. The Wheatstone bridge is an electrical circuit used to measure an unknown electrical resistance by balancing two legs of a bridge circuit. One leg includes the unknown component and three legs are formed by a resistor having a known electrical resistance. In this configuration, the four strain gauges replace the three known resistors and one unknown component. Instead of balancing the resistors to get a nearly zero output, a voltage output Vₒᵤₜ is generated with the resistances of the strain gauges 302A (S1A), 302B (S1B), 316A (S2A), and 316B (S2B). A moment applied to the free end 312 of the beam 306 induces resistance change in each strain gauge. The output nodes are 512a, 512b, 512c, and 512d, which are also shown in FIGS. 6B and 6C as electrical contact 512.

FIG. 6A is a top view of a moment-compensated bending beam sensor device in accordance with an embodiment. The sensor device 600 includes a bending beam 306 and two strain gauges on a common carrier 602A and aligned with the bending beam 306. The beam sensor 600A is placed on the beam such that strain gauge S1 is near electrical contact 614 (which is closer to the beam base 304) and strain gauge S2 is closer to the free end 312 where the force is applied. It may be useful to have the electrical contact 614 of the sensor 600A positioned away from the loading position to avoid damage to the contacts or unnecessarily extending electrical contacts along the length of the beam, although it should be understood that alternative embodiments may orient the sensor differently. The carrier 602A or sensor 600A is aligned with the central X-axis of the beam. In this embodiment, Vexc+ is connected to beam sensor 302 and Vexc− is connected to beam sensor 316. The output Vₒᵤₜₚᵤₜ is connected between sensors 302 and 316.

FIG. 6B is a top view of a moment compensated bending beam sensor including four strain gauges on a common carrier 602B aligned with a bending beam 306 in another embodiment. Again, the sensor 600B is placed on the beam 306 such that the electrical contact 512 is closer to the beam base 304 and further away from the free end 312 of the beam. The electrical contact 512 includes four output nodes from the Wheatstone bridge. The electrical contact 512 may also include a wire bond pad for temperature compensation. Again, the carrier with the strain gauges S1A, S1B, S2A, and S2B is aligned with the central X-axis of the beam.

FIG. 6B also shows a wiring layout of the four strain gauges, connected in a Wheatstone bridge, in a moment-compensated bending beam sensor in one embodiment. In this scheme, electrical contact pads 604B are connected to nodes 512a-d as shown in FIG. 5. In this embodiment, positive input voltage Vexc+ is connected to beam sensors S1A (302A) and S2B (316B) and negative input voltage Vexc− is connected to sensors S1B (302B) and S2B (316B). One side of the differential output, negative output Vout−, is connected between sensors S1A (302A) and S2A (316A) and the second side of the differential output, positive output Vout+, is connected between beam sensors S1B (302B) and S2B (316B).

Aluminum and steel are popular choices for a beam material. They are commonly available in many useful preformed sizes and strain sensors are available with built in compensation for thermal expansion. Other materials are possible, including titanium, plastic, brass and so on.

Additionally, this disclosure provides a method for implementing a plate mounting scheme, where the plate is supported on its four corners by four bending beams. The plate is attached to the beams in any suitable fashion, such as by a viscoelastic polymer. In alternative embodiments, the plate may be attached to the beams with adhesive, through welding, mechanical fixtures and the like.

Each of the four bending beams has a bending beam sensor including strain gauges. The gel 310 may exhibit a viscoelastic response and change shape in response to the applied force with a time constant of seconds. As the gel changes shape, the location of the applied force shifts. Because the strain gauges are moment insensitive, the outputs of the strain gauges are not affected by this viscoelastic response of the polymer.

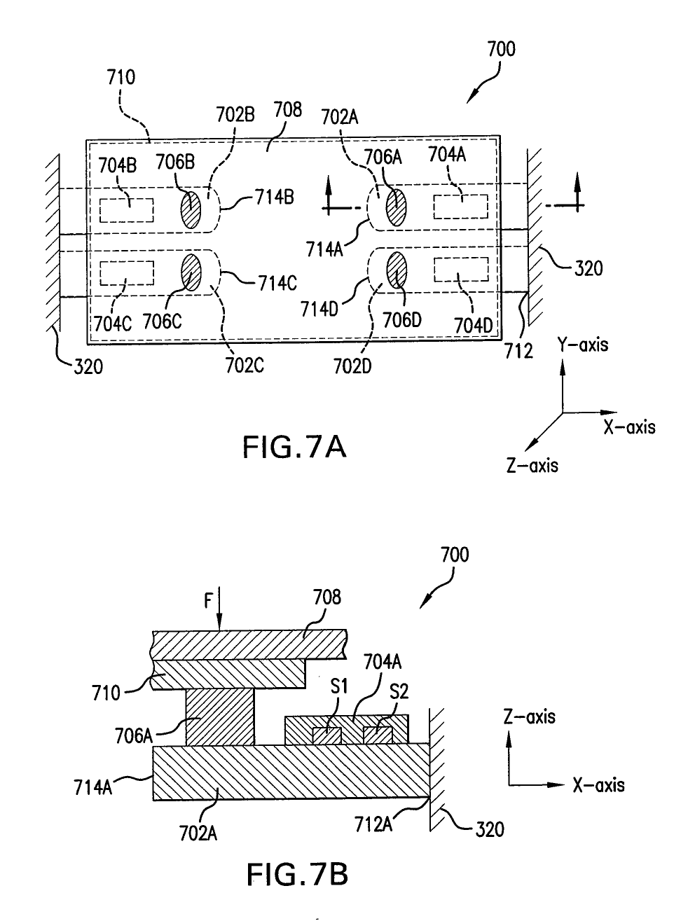

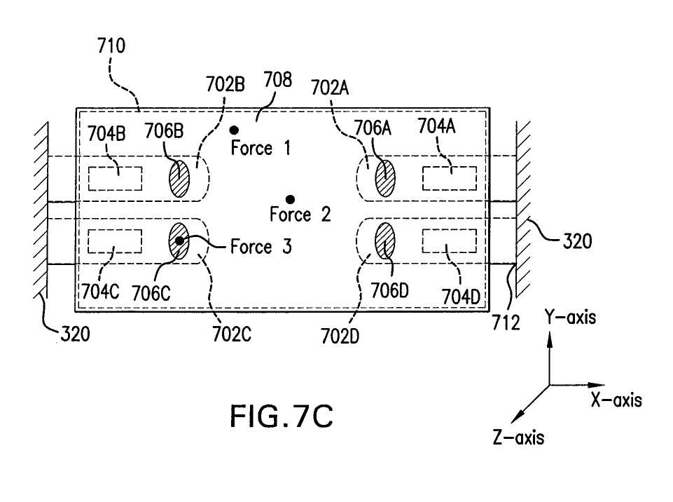

FIG. 7A is a top view of a system diagram for a trackpad 700. Dashed lines indicate elements that ordinarily are not visible in the view of FIG. 7A, but are shown to illustrate certain principles of the invention. The trackpad 700 includes a platform or plate 708 which may be supported by four bending beams 702A-D and also includes four moment-compensated bending beam sensors 704A-D. The trackpad plate 708 is coupled to the four bending beams near four corners of the plate. The coupling is achieved by bonding the plate to the aforementioned gel 706A-D. The gels may be in any shape including circular and non-circular shapes. For example, FIG. 6A shows a gel having a circular cross-section while FIG. 7A shows a gel having an oval cross-section. Other shapes (either planar or three-dimensional) may be used in varying embodiments. Although the gels are shown in the figures, the gels may be removed in some embodiments. A position sensor 710 may be placed at or near the gel/plate coupling, along a surface of the plate 708. The position sensor 710 is under the trackpad, as shown by dashed lines. Also, the position sensor may include a position sensing layer as large as the platform 708 of the trackpad in a form of grid.

Each moment compensated beam sensor includes at least two strain gauges which are wired together to produce a differential signal in one embodiment. In an alternative embodiment, each moment compensated beam sensor includes four strain gauges which can be wired as a Wheatstone bridge. For the plate, load signals can be obtained from the bending beam sensors in order to determine the force exerted on the trackpad, and load position signals can be obtained from the position sensors.

In a particular embodiment, the bending beam may be approximately 10 mm wide, 10 mm long and 0.5 mm thick, and the trackpad may be approximately 105 mm long and 76 mm wide with thickness ranging from 0.8 mm to 2.3 mm.

It will be appreciated by those skilled in the art that the dimension of the beam may vary for various desired loads and electrical outputs as well as the dimension and shape of the platform.

In certain embodiments, a position-sensing layer may underlie the plate. The position-sensing layer may be, for example, a capacitive sensing layer similar to that employed by many touch screens. The capacitive sensing layer may include electrodes arranged in rows and columns and operative to sense the particular position of a touch. In some embodiments, the position-sensing layer may sense multiple simultaneous touches in a fashion similar to that of a touch screen incorporated into a smart phone, tablet computing device, media player, computing display, touch screen, and like products. As the operation of the touch-sensitive layer is known in the art, it will not be discussed further herein.

It should be appreciated, however, that the position sensing and force sensing of the trackpad may be combined. Accordingly, the various discussions herein regarding force sensing may be applied to a capacitive sensing layer and/or a capacitive sensing display, as well as any other computing element or enclosure that may be touched or pressed upon. Accordingly, embodiments described herein may be configured such that forces applied to a display or other computing element may be sensed. The trackpad plate may be replaced by a cover glass or surface of a mobile device or the like, for example, and forces on such a surface sensed.

In a particular embodiment, the beam has a uniform thickness to reduce the overall dimensions of the trackpad. For certain applications, such in a tablet computing device, media player, portable computer, smart phone, and the like, a connection between the plate and the beams through a viscoelastic polymer, such as a gel, may be thin.

FIG. 7B is a cross-sectional view through bending beam 702A of FIG. 7A. In this figure, a trackpad plate 708 has position sensor 710 attached. The position sensor 710 is attached to the beam 702A through gel 706A. Note that each of moment-compensated bending beam sensors 704A, 704B, 704C, and 704D includes at least two strain gauges S1 and S2 or two pairs of strain gauges, i.e. four strain gauges.

FIG. 7C illustrates three force locations on platform 708. Force 1 is closer to beam 702B than the other three bending beams and more force will be carried by bending beam 702B than the other beams. To accurately determine the magnitude of Force 1, the forces detected by each of the individual force sensors 704A, 704B, 704C and 704D can be summed. Alternatively, the output of the position sensor 710 can be used with the output from one or more moment compensated bending beam sensors to correlate a position of a touch or other input with a load magnitude. These methods of determining the force magnitude can be used whether the load is applied near the center of the trackpad for Force 2 or at any position on the surface of the platform 708 such as where Force 1 and Force 3 are located.

In some cases, it is desired to approximately determine the force location without using the position sensor or position-sensing layer 710. For each moment compensated beam sensor, the force detected by the beam sensor is multiplied by the position along the central axis of the beam that the force is applied to the individual beam forming a force distance product. The force distance products of all four beams are summed and divided by the total force. The resulting position approximates the position of the force relative to the center of the trackpad. Essentially, the use of three beam sensors permits triangulation of the location of a force by comparing the relative magnitudes of the forces sensed by each beam sensor, although four bending beams are shown in FIG. 7C. Accordingly, each of the beam sensors may be connected to a processor or other computing element that may use the output of the beam sensors to triangulate a location at which a force is applied. This location data may be compared to, or correlated against, load data obtained from the position sensor such that a particular force may be correlated with a particular touch input.

Further, in the case of multi-touch gestures, the location and magnitude of multiple forces may be determined from the outputs of the position sensor and the bending beam sensors, each load correlated with a different touch on the trackpad or other input mechanism. For example, when using two or more fingers to touch a track pad simultaneously, it is required to determine the location and magnitude of multiple forces.

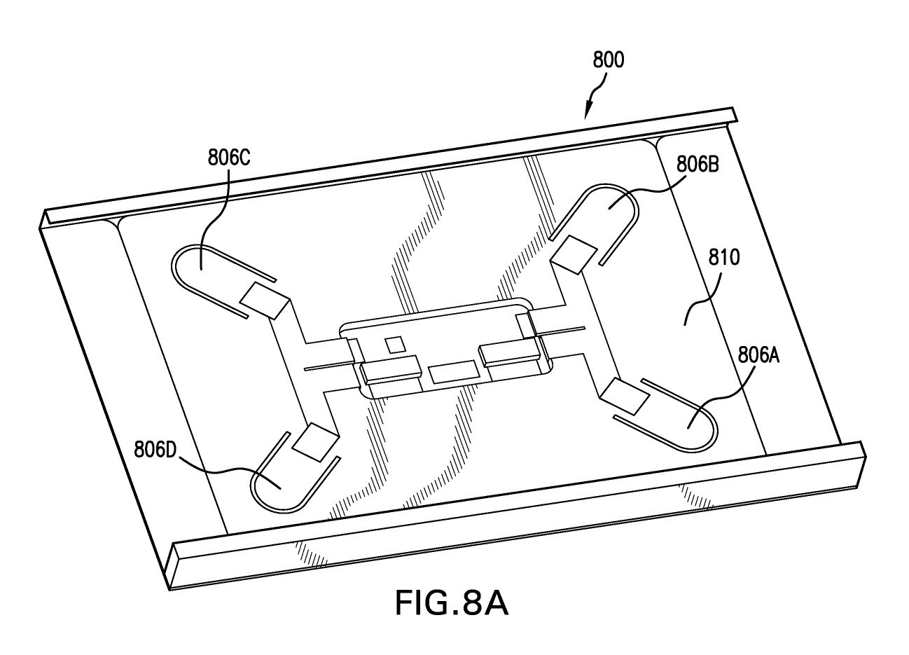

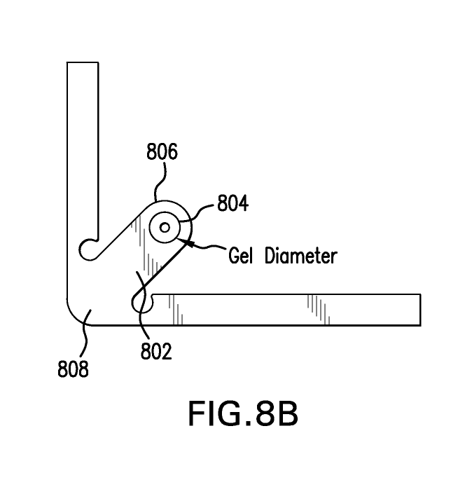

FIG. 8A is a perspective view of the bottom of a trackpad with four bending beams at the corners in another embodiment. Note that the bending beams 806A-D are entirely within the footprint of the trackpad plate 810. In contrast, the bending beams may extend beyond the edges of the trackpad plate, as shown in FIG. 7A.

FIG. 8B is an enlarged view of one of the four bending beams at a corner in another embodiment. Note that the gel 804 has a circular cross-section and covers, or nearly covers, a free end 806 of the bending beam 802. The opposite end of the beam is attached to a base 808, such as a sidewall of a computing device housing, or a support extending from, or part of, a computing device housing. It should be appreciated that the size, shape and configuration of any portion of the trackpad, including the gel, beams and bases, may vary from embodiment to embodiment. Accordingly, the configurations shown in FIGS. 8A-B are illustrative of two implementations and are not intended to be limiting.

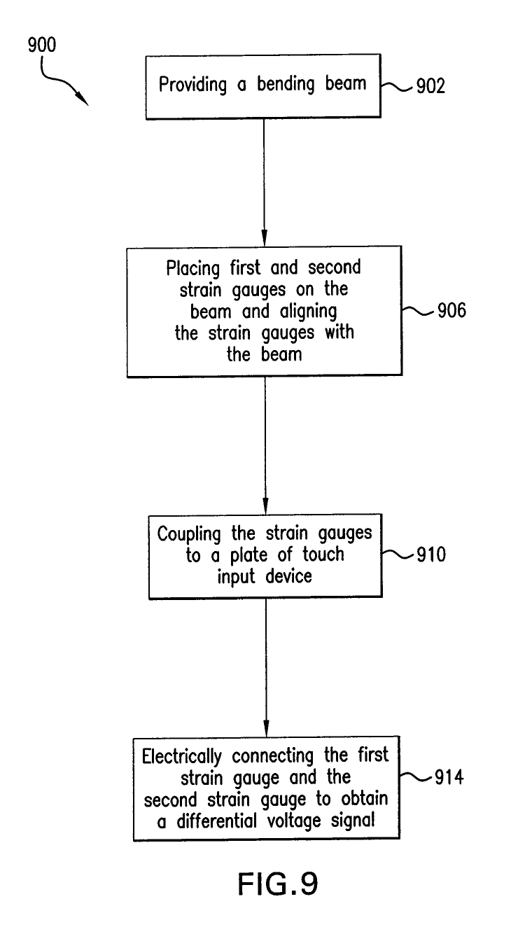

FIG. 9 is a flow chart illustrating the steps for fabricating a moment compensated bending beam sensor coupled to a touch input device in an embodiment. Method 900 starts with providing a bending beam at operation 902. Method 900 continues with placing a first strain gauge and a second strain gauge on a surface of the beam near a first end of the beam aligning the first strain gauge and the second strain gauge with the beam along an axis at operation 906. The first end is attached to a base. Method 900 also includes coupling the first strain gauge and the second strain gauge to a plate of the touch input device at operation 910. Method 900 further includes electrically connecting the first strain gauge and the second strain gauge such that a differential voltage signal is obtained from the first strain gauge and the second strain gauge when a load is applied on the plate of the touch input device at operation 914.

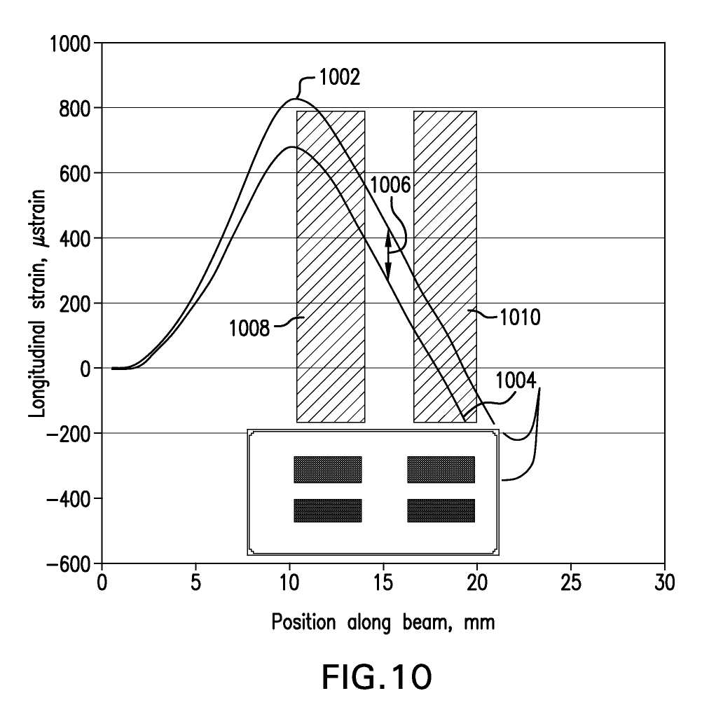

FIG. 10 illustrates exemplary strain profiles with a moment compensated bending beam sensor including two strain gauges aligned with a beam. The strain profiles are measured along the central axis of a single beam with the design shown in FIG. 3E when a trackpad is supported by four beams as shown in FIG. 7. The zero position is set at the left hand side of the beam that lies over the flexible support 332. The peak in the strain profile occurs at the edge of the support shelf. The gel is located from position 21 mm to position 27 mm. The bending beam extends from the flexible support 332 to the edge of the gel and is 17 mm long. When a load is applied at the center of the trackpad, similar to Force 2 in FIG. 7C, strain profile 1002 is obtained. In contrast, strain profile 1004 occurs if the load is applied directly over the gel, similar to Force 3 in FIG. 7C. The central load produces 25% more strain near the beam base or root 304 of the beam. A standard bending beam strain sensor located near the root would not give an accurate reading of the force carried by the beam. The differential sensor or moment compensated sensor described in this disclosure gives a reading that is independent of the force location. The strain gauge 302 provides a signal that is proportional to the average strain over the left hand grey band 1008. The strain gauge 316 provides a signal that is proportional to the average strain in the right hand grey band 1010. Because the bending beam sensor including the two strain gauges 302 and 316 subtracts these two signals, the output is only a function of the slope of the two curves. Note that a load curve over the gel 1004 has the same slope as the load curve over the center of the trackpad 1002 even though it is shifted down by an amount 1006. Thus, the moment-compensated strain sensor provides an output which is nearly independent of the location of the applied force. The non-uniformity is approximately 1-2%.

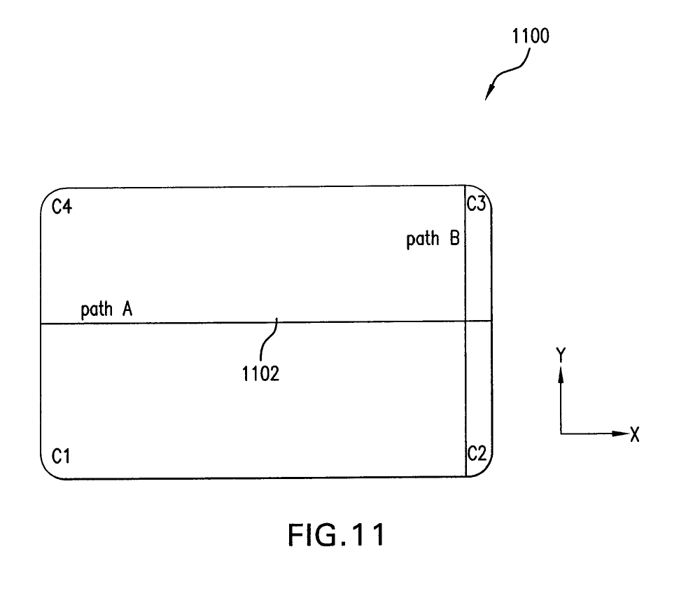

FIG. 11 is an exemplary trackpad in accordance with a sample embodiment. The trackpad 1100 includes four corners C1, C2, C3, and C4. The trackpad 1100 has a center 1102, a path A along an X-axis through the center and a path B along a Y-axis at a distance from an edge of the trackpad. The trackpad 1100 also has a substantially rectangular shape with round corners. It will be appreciated by those skilled in the art that the shape and dimension may vary.

A moment compensated bending beam sensor may be used for both relatively thin platforms, such as those approximately 0.8 to 1.0 millimeters thick or less, and relatively thick platforms. “Relatively thick,” as used here, refers to platforms having a thickness approximately equal to, or greater than, 2.3 millimeters Some examples are shown below.

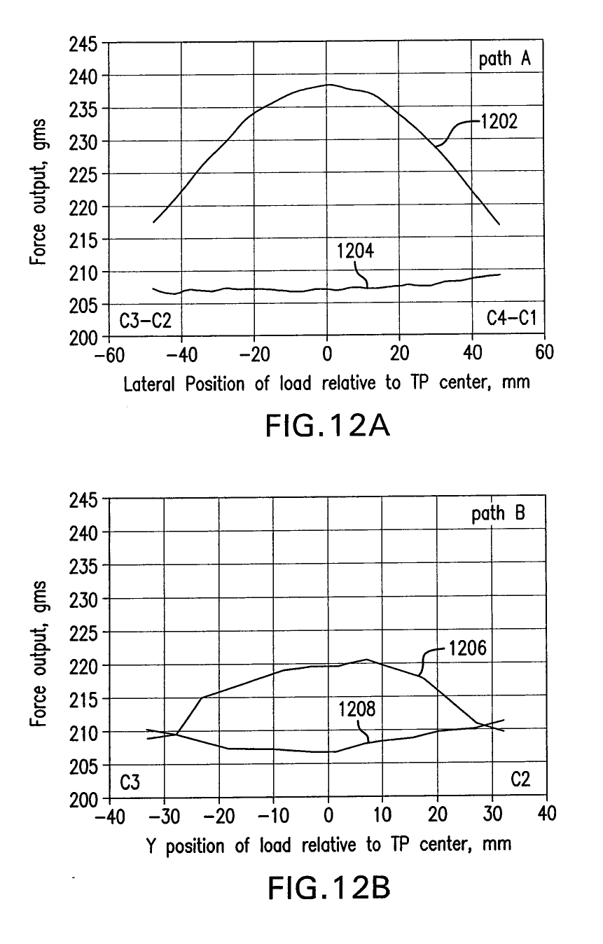

FIG. 12A illustrates force output formed by the sum of forces measured by each of the individual sensors along path A of FIG. 11 from a moment compensated bending beam sensor for a 0.8 mm thick platform when a 210 gram force is applied on the trackpad. As shown, the moment compensated bending beam sensor exhibits less than 2% non-uniformity, illustrated by curve 1204. In contrast, the standard bending beam strain sensor exhibits force output of curve 1202 and a non-uniformity of about 13.5%, as shown by curve 1202. It should be appreciated that the output shown in FIG. 12A is dependent on a variety of factors, physical constraints, and the like, and accordingly is intended to be illustrative. Alternative embodiments may have different force outputs in response to different forces, and thus the graphs shown should not be considered limiting.

FIG. 12B illustrates a force output along path B of FIG. 11 from a moment compensated bending beam sensor for a 0.8 mm thick platform when a 210 gram force is applied on the trackpad. As shown, the moment compensated bending beam sensor exhibits less than 2% non-uniformity, as shown by curve 1208. In contrast, the standard bending beam strain sensor exhibits a load variation from about 209 grams to about 221 grams which yields a non-uniformity of about 13.5%, as shown by curve 1206. It should be appreciated that the output shown in FIG. 12A is dependent on a variety of factors, physical constraints, and the like, and accordingly is intended to be illustrative. Alternative embodiments may have different force outputs in response to different forces.

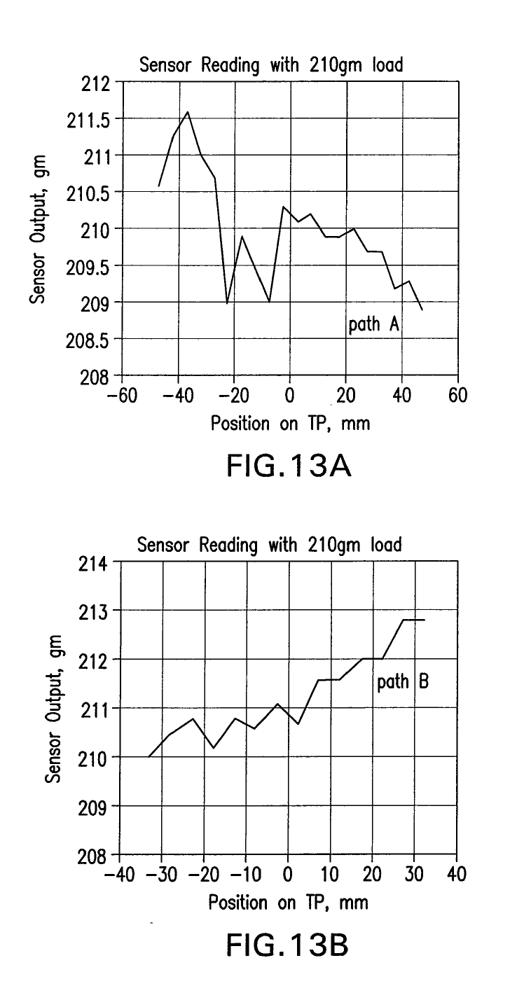

FIG. 13A illustrates a force output along path A of FIG. 11 from a moment compensated bending beam sensor for a 2.3 mm thick platform when a 210 gram force is applied on the trackpad. Note that the sensor output varies from about 209 grams to 211.5 grams along path A. The load variation is about 2.5 grams along path A, which suggests a uniformity of load of about 99% along path A. FIG. 13B illustrates force output along path B of FIG. 11 from a moment compensated bending beam sensor for a 2.3 mm thick platform. Again, a 210 gram load is applied on the trackpad. The measured sensor load varies from 210 grams to about 213 grams along path B, which yields a load uniformity of about 98.6% along path B.

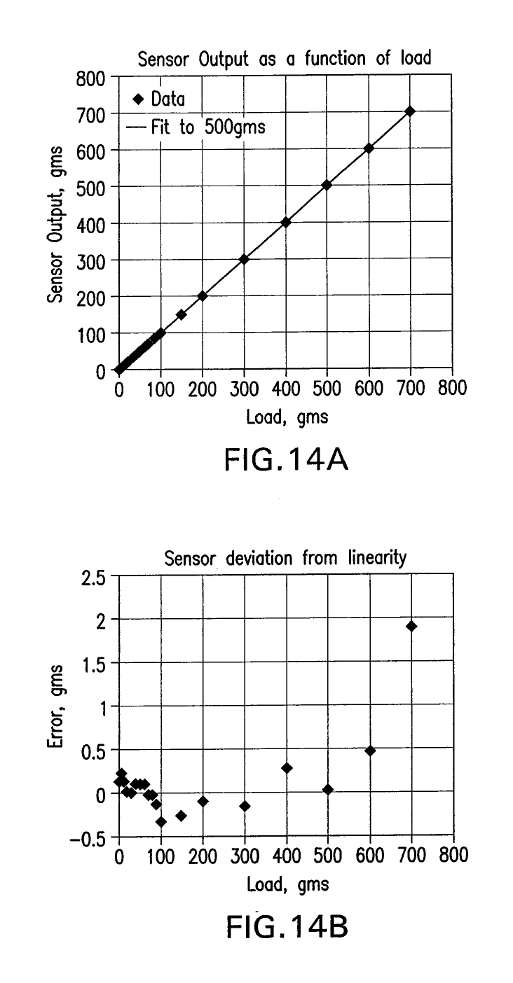

FIG. 14A illustrates the linearity of a moment compensated bending beam sensor output as a function of load for a 2.3 mm thick platform. Note that the moment compensated bending beam sensor is very linear in its load response. The load ranges from 0 to 700 grams. FIG. 14B illustrates a moment compensated bending beam sensor deviation from linearity for a 2.3 mm thick platform. It shows that the error in load is less than about 0.3 grams for load up to 500 grams. It should be appreciated that the outputs shown in FIGS. 13A, 14B and 14 are dependent on a variety of factors, physical constraints, and the like, and accordingly are intended to be illustrative. Alternative embodiments may have different force outputs in response to different forces, and thus the graphs shown should not be considered limiting.

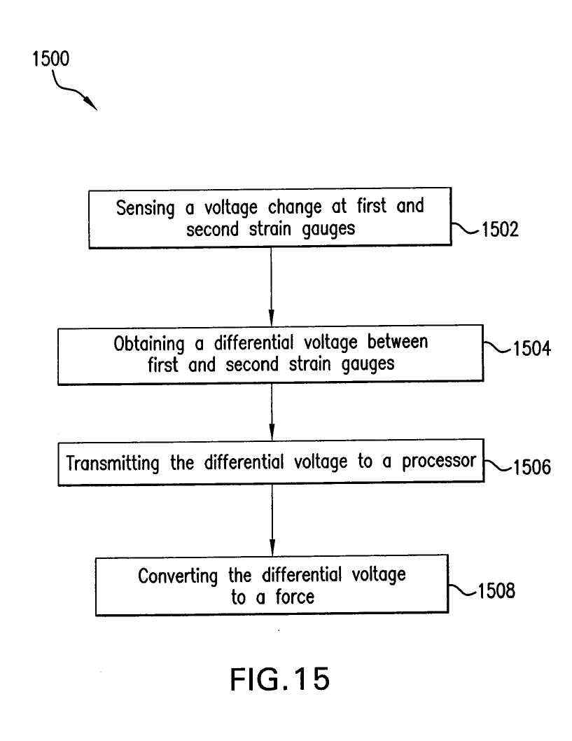

FIG. 15 is a flow chart illustrating the steps for determining a force and a location of the force for a trackpad with a moment compensated bending beam sensor in an embodiment. Method 1500 starts with sensing, at a first and a second strain gauges, the voltage change on the plate at operation 1502. The first and the second strain gauges are positioned on a common side of a single beam coupled to the plate. Then, method 1500 is followed by operation 1504 for obtaining a differential voltage between the first strain gauge and the second strain gauge. Method 1500 continues to operation 1506 for transmitting the differential voltage to a processor and operation 1508 for converting the differential voltage to a force on the plate.

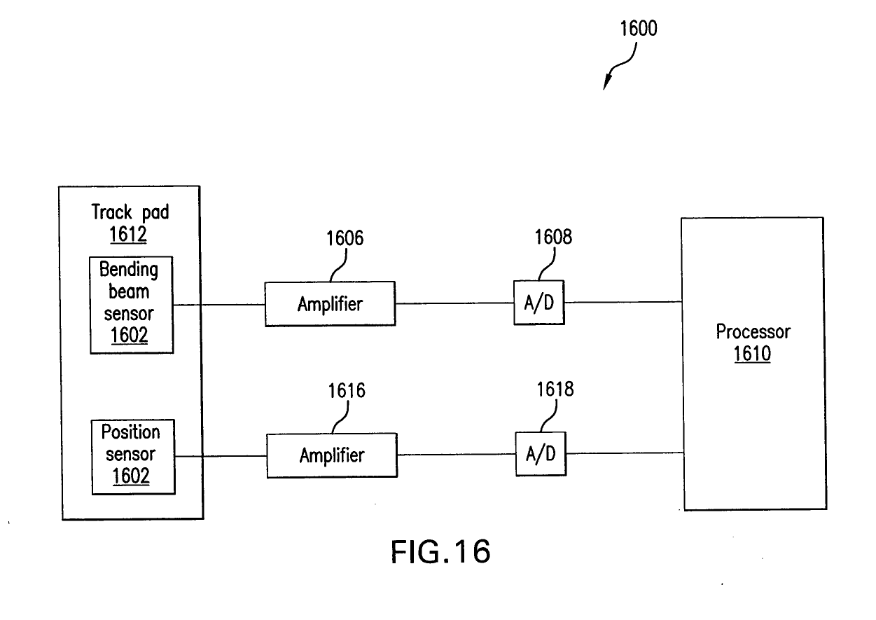

FIG. 16 is a simplified system diagram for processing the signals from trackpad in an embodiment. System 1600 includes a trackpad 1612 that includes a platform supported by at least one bending beam or multiple bending beams. Each bending beam includes one moment compensated bending beam sensor 1602. The moment compensated bending beam sensor 1602 is coupled to an amplifier 1606 that is coupled to an analog-to-digital (A/D) converter 1608. Each bending beam also includes one position sensor 1604. The position sensor 1604 is coupled to an amplifier 1616 that are coupled to an analog-to-digital (A/D) converter 1618. A processor 1610 is coupled to the A/Ds 1608 and 1618 to process the force signal and position signal to determine the magnitude and position of a force or multiple forces.

The moment compensated bending beam sensors may include one or more strain gauges to measure force. The position sensors 1604 may include capacitive measuring electrodes. The trackpad is a touch input device which is different from a simple binary mechanical switch, which may be in an “on” or “off” state. The touch input device can measure a variable force or a constant force and output more than “over threshold” or “under threshold”. The platform may be optically transparent or opaque.

It should be appreciated that the present embodiment employs a double bending beam strain gauge but does so on a non-standard beam. That is, the beam itself is not a double-bending (or contraflexured) beam. In contrast to double bending beams, neither the angle of the beam 306 at its root or the angle of the beam at the free end are constrained to be fixed or parallel. The beam largely deforms along a single curve when a force is applied instead of bending into an S-shape like a double-bending beam. Further, unlike many contraflexured beams, the present beams may have a relatively uniform thickness. Many contraflexured beams are thinner in cross-section at one point along their length to induce the S-shape curvature when the beam is loaded. In an alternative embodiment, the beam thickness may vary. For example, the beam thickness in the strain gauge area or an active area may vary from a non-active area without the strain gauge. Still further, some embodiments discussed herein generally place all strain gauges on a single side of each beam rather than distributing them across opposing sides as may be done with both contraflexure beams and single-bending beams. In this invention, the strain sensors have been described as resistive gauges in which the resistance is proportional to the beam strain. It will be recognized by those skilled in the art that semiconductor strain gauges, micromachined strain gauges or optical strain gauges could also be employed in a similar fashion to provide a signal that is independent of the load position.

Moreover, the signals from the differential strain gauges 302 and 316 may be combined in a Wheatstone bridge; however, in some instances, it may be desirable to convert the electrical signals from the differential strain gauges separately into digital form. These digital signals could then be scaled and subtracted to provide a moment compensated signal. Independent scaling of the two gauge signals may be especially desired when the thickness of the beam varies between the location of strain gauge 302 and strain gauge 316.

Generally, the force sensed by embodiments disclosed herein may be used to provide haptic feedback. The haptic feedback may vary not only with the amount of force applied, but the speed with which the force is applied, the number of unique touches sensed by the position sensor, the software operating on the computing device housing the embodiment, the status of the computing device and/or software, and so on. Broadly, the trackpad plate 108 may be moved laterally through applications of magnetic force. Magnetic force may be exerted by an electromagnetic actuator to push the trackpad plate in one or more lateral directions, for a specific time and with a specific kinetic energy. The time and/or energy of the trackpad plate 108 may be varied by changing an input waveform to the electromagnetic actuator. To facilitate such motion, the trackpad plate may be formed from a metal or other magnetically-sensitive material. Thus, the gel(s) are passive support structure(s) rather than active ones. That is, the gels themselves do not act to impart motion or displacement to the haptic response element, such as the trackpad plate. Rather, the haptic response element is displaced through the action of the electromagnetic actuator. The gels act to provide support to the haptic response element and return it to a neutral position.

It should be appreciated that the trackpad plate 108 may be either pushed or pulled through operation of the electromagnetic actuator, depending on the material of the plate and the polarity of the actuator. Generally, the trackpad plate 108 is moved in a single direction by the magnetic field generated by the actuator, from a starting (or neutral) position to a maximum travel position. The gel 110 may act as a spring to return the trackpad plate to its starting position when the magnetic field is terminated.

The gel 110 may function not only as spring to bias the trackpad plate 108 back to its original position, but also as a damper. That is, the gel may act to damp the trackpad motion on its return from a travel position to its starting position. In this manner, the trackpad plate 108 does not overshoot the starting position and oscillate when the electromagnetic actuator is not active. Thus, the gel 110 essentially damps the trackpad plate but still permits the plate to return to the neutral position. The gel may thus be thought of as a strictionless damping spring that permits a return to a zero (e.g., start) position. Further, the material properties of the gel may be selected to provide certain levels of damping as desired. That is, in some embodiments the gel material may be selected to damp motion to a greater or lesser extent.

It should be appreciated that the motion of the trackpad plate 108 is in shear with respect to the gel 110. The gel 110 does not enter compression during the trackpad plate's motion. Accordingly, the gel is less likely to rupture or fail during operation of the trackpad.

As previously mentioned, the gel may have any number of different cross-sections in various embodiments. Circular and oval cross-sections have been shown and described with respect to at least FIGS. 3B and 7A. Similarly, rectangular and triangular cross-sections may be used in different embodiments, as may half circles, semicircles, arc segments, rhomboids, and any other desired cross-section. By changing the geometry of the gel 110, the haptic response provided by motion of the trackpad may likewise be changed. Certain geometries (including cross-sections) may permit greater or lesser motion of the plate when the same magnetic force is applied thereto. Likewise, the speed with which the plate returns to the start position from the travel position may vary with the geometry of the gel. Further, modifying the geometry of the gel may affect the moment of the force applied on the trackpad plate and/or the trackpad's torsional stiffness. As an example, a gel with a rectangular cross-section may reduce shear stiffness in a direction parallel to the shorter dimension of the rectangular cross-section when compared with the shear stiffness in a direction parallel to the longer dimension. It should be appreciated that, in addition to the cross-section, the thickness and other dimensions of the gel are included in the term “geometry,” as applied to the gel 110.

Likewise, the distance of the gel 110 from the center of the trackpad plate 108, corners of the plate, and/or its position along the beam (e.g., the alignment of the gel) may all affect the haptic response of the plate, as well as its moment and/or stiffness. Gels may be formed to provide greater stiffness in one direction than another, for example, by controlling the geometry of the gel.

The size, durometer and/or area of the gel may further affect these parameters. As another example, increasing the width of a rectangular gel, or the diameter of a circular gel 110, may increase the uniformity of the force sensor readings with respect to one another. The gel may be from 0.1 mm to 1.0 mm thick in certain embodiments, although thicker and thinner gels may be used. As one particular example, the gel 110 may be made from, or constitute, a material having relatively strong internal damping characteristics to control resonant response of the haptic output. A gel having a higher internal damping characteristic may provide greater damping of a haptic response element's motion, which in turn may provide a more solid or precise feel for a user. Certain materials, such as urethane and thermoplastics having high material loss factors, may be suitable for use as a gel 110.

In still other embodiments, multiple, smaller gel patches may be used in place of a single gel 110. By using multiple small gels, sufficient area for adhesion of the haptic response element and/or a support surface may be provided while shear stiffness of the gel layer is reduced. As another option, one or more surfaces of the gel 110 may be sliced, scored or sheared to reduce shear stiffness. Such alterations of a gel surface may be made whether a single gel patch or multiple gels are employed. By slicing, perforating, scoring or shearing the surface of the gel, shear stiffness may be reduced while the contact area size is maintained, thereby permitting formation of an adhesive bond between the gel and adjacent surface.

In certain embodiments, the gel 110 may provide other functionality. For example, the gel may control or impact an acoustic response of a haptic response element. As an example, the gel 110 may facilitate a soft coupling between the haptic response element and a support structure, as well as other portions of an embodiment. This soft coupling may reduce the audible noise generated in response to a sharp impulse input to the actuator or other sharp impulse displacing the haptic response element. Thus, the gel may make operation of an embodiment quieter.

Additionally, the gel 110 may accommodate thermal mismatches between a haptic response element and support structure. The gel 110 may serve as an insulating barrier between the two, thereby preventing or reducing buckling, warping, shifting, bending, cracking and the like of either the response element or support structure in response to a thermal mismatch. Essentially, the gel 110 may prevent stresses from being generated in either element due to thermal mismatching.

Some embodiments may employ a hinged or pivoting gel. A gel that pivots with respect to the beam (and trackpad plate) may cancel any moments resulting from application of force to the plate.

Sample gels 110 may be made from a low durometer silicone rubber or other silicone-based material. In alternative embodiments, a foam may be used. In still other alternative embodiments, certain rubbers or other polymers may be suitable for use as a gel.

The gel 110 generally connects the trackpad plate to the beam. The gel may chemically bond to one or both of the plate and beam, thereby reducing or eliminating the need for a separate adhesive. In one embodiment, a steel piece (either or both of the plate and beam) may be primed with a primer. The gel may be injection molded onto the primed surface, chemically bonding thereto. A silicone-based adhesive may be placed on the other surface of the gel and adhered to the other element or another portion of the trackpad stackup.

It should be appreciated that the gel described herein may be used in or with any of the embodiments disclosed herein. Accordingly, although reference numeral 110 has been used to describe the particular gel, gels 310, 702, 706 and so on are also intended to be embraced by the foregoing description.

Further, it should be appreciated that any haptic response element may employ a gel, as described herein, in order to control its haptic response. By placing the gel in shear with respect to the moving part of the haptic response element, certain advantages and benefits may be obtained as described herein.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. An apparatus, comprising:
a moving part;
a stable part;
a gel linking the moving part and the stable part, the gel configured to experience a shear force when the moving part moves; and
a force sensor affixed to the stable part and operative to sense a force exerted on the moving part; wherein
the gel is configured to provide a first shear stiffness along a first axis and a second shear stiffness along a second axis, the first and second shear stiffnesses being different from one another.

2-3. (canceled)

4. The apparatus of claim 1, further comprising an actuator coupled to the stable part, the actuator configured to displace the moving part in response to an actuation signal.

5. The apparatus of claim 4, wherein the gel returns the moving part to a neutral position when the actuation signal ceases.

6. The apparatus of claim 5, wherein the gel functions to damp a return motion of the moving part.

7. The apparatus of claim 6, wherein the gel is striction-free.

8. The apparatus of claim 4, wherein the actuator is an electromagnetic actuator.

9. The apparatus of claim 1, wherein the gel comprises:
a first surface; and
a second surface opposing the first surface, the second surface at least partially discontinuous, thereby reducing a shear stiffness of the gel in a direction.

10. The apparatus of claim 9, wherein the at least partially discontinuous surface comprises one of a slice, a score, or a perforation.

11. The apparatus of claim 1, taking the form of a trackpad.

12. The apparatus of claim 1, taking the form of a button of an input device.

13. An output device, comprising:
a plate;
at least one gel affixed to the plate;
at least one support affixed to the at least one gel;
at least one force sensor affixed to the at least one support;
at least one haptic actuator operably connected to the plate; wherein
the at least one sensor is configured to receive an input from the plate, the input transmitted through the gel; and
the at least one haptic actuator is operative to move the plate in response to the input.

14. The output device of claim 13, wherein the gel reduces a thermal mismatch between the plate and the at least one support.

15. The output device of claim 13, wherein the gel is configured to elastically deform in response to a force exerted on the plate, and further configured to return to a default configuration in the absence of a force exerted on the plate.

16. The output device of claim 13, wherein the plate is configured to move in response to the force.

17. The output device of claim 16, wherein the gel returns the plate to an initial position after the motion of the plate.

18. The output device of claim 16, wherein the gel passively supports the plate.

19. The output device of claim 13, wherein the gel pivots with respect to the support in response to a force exerted on the plate.

20. The output device of claim 13, wherein:
the plate is configured to transmit a haptic output in response to the input; and
the gel at least partially shapes the haptic output.

21. The apparatus of claim 1, wherein the gel thermally insulates the moving part from the stable part.

22. The apparatus of claim 1, wherein the first axis is perpendicular to a planar surface of the moving part and the second axis is parallel to the planar surface of the moving part.
